(19) United States
(12) Patent Application Publication
(10) Pub. No.: US 2006/0002638 A1
(43) Pub. Date: Jan. 5, 2006

(54) Fixed shaft type fluid dynamic bearing motor

(75) Inventor: Yoshikazu Ichiyama, Kyoto-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Kura Laboratries Corporation, Kyoto-city (JP)

(21) Appl. No.: 11/074,055

(22) Filed: Mar. 8, 2005

(30) Foreign Application Priority Data
Jul. 2, 2004 (JP) JP2004-196174
Jul. 6, 2004 (JP) JP2004-199022
Aug. 4, 2004 (JP) JP2004-227399

(51) Int. Cl. F16C 32/06

(52) U.S. Cl. 384/100

(57) ABSTRACT

A fixed shaft type fluid dynamic bearing motor having two interfaces of a lubricating fluid. A channel leading from near the top end of the inner periphery of a rotating sleeve to near the periphery of the bottom of the sleeve is formed in the sleeve. The lubricating fluid flows into the channel by centrifugal force, and further conveyed to near the periphery of the bottom of the sleeve by centrifugal force and/or by slanted channel in circumferential direction. A dynamic-pressure generating groove for pumping the lubricating fluid toward the top end of the sleeve is formed between the fixed shaft and the sleeve. The dynamic-pressure generating groove and the centrifugal force cause the circulation of the lubricating fluid, thereby sealing the lubricating fluid. A cone bearing or a cylindrical bearing can be used for bearing configuration. Also, the axial space smaller than that of tapered seals can be utilized.

### BACKGROUND OF THE INVENTION

1. Field of the Invention

The invention relates to a fluid dynamic bearing motor for a recording disk drive, and more particularly to a fixed shaft type fluid dynamic bearing motor which uses a novel lubricating fluid sealing structure as an alternative to conventional tapered seals.

2. Description of the Related Art

The dominant bearing structure in conventional fluid dynamic bearing motors for magnetic disk drives (HDDs) has been a rotating shaft structure in which a lubricating fluid and air form only a single interface to facilitate sealing in the lubricating fluid. However, such fluid dynamic bearing is suffering from a number of disadvantages, for example, it could be sensitive to external vibration, imbalances and shock.

A desirable solution to this problem would be to have the spindle motor attached to both the base and the top cover of the disk drive housing. This would increase overall drive performance. A motor attached at both ends is significantly stiffer than a rotational shaft bearing. And also, the existence of the motor shaft that supports the top cover of the housing should be big advantage for the extremely small disk drive.

All of the known fluid dynamic bearing designs for a motor attached at both ends has not been easy to realize. The reason for this is that in order to have top cover attachment, the motor and specifically the bearing would need to be open on both ends. Opening a motor at both ends greatly increases the risk of oil leakage out of the fluid dynamic bearing. This leakage is caused by, among other things, small differences in net flow rate created by differing pumping pressures in the bearing. If all of the flows within the bearing are not carefully balanced, a net pressure rise toward one or both ends may force fluid out through the capillary seal. Moreover, due to manufacturing imperfections of the bearing, the gap in the bearing may not be uniform along its length and this can create pressure imbalance in the bearing and hence, cause leakage when both ends of the fluid dynamic bearing are open. The net flow due to pressure gradients in a bearing has to be balanced by all the bearings individually for the fluid to stay inside the bearing. Any imbalances due to pumping by the grooves of the bearings will force the fluid out of the capillary until the meniscus at one end moves to a new equilibrium position.

Nevertheless, most of the fluid dynamic bearing motors fixed or attached at both ends achieved in the past are for large-sized structures which are adapted to carry a number of magnetic disks for high speed rotation. Thus, it is difficult to employ the structure of these motors for small-sized drives which carry and drive no more than two small magnetic disks or the like.

More specifically, the fluid dynamic bearing motors fixed or attached at both ends have many parts arranged in the axial direction, e.g., having one or more thrust plates. Thus, if such structure is simply miniaturized for use in a small sized motor, the same arrangement cannot secure the span between the upper and lower radial bearings, failing to maintain low non-repetitive runout during rotation. Above all, the greater number of parts makes cost reduction difficult.

For the fixed shaft type fluid dynamic bearing motors that are applicable to low-profile HDDs, single cone bearings have been proposed in Japanese Unexamined Patent Application Publication No. Hei 06-315242 and U.S. Pat. No. 6,686,674, and single thrust bearing structures have been proposed in U.S. Pat. No. 6,211,592 and Japanese Unexamined Patent Application Publication No. 2004-173377.

The single cone bearing proposed in Japanese Unexamined Patent Application Publication No. Hei 06-315242 and U.S. Pat. No. 6,686,674 are of a rotating shaft structure or single end-tied fixed shaft structure, and thus cannot be applied to fluid dynamic bearing motors with its shaft attached at both ends directly.

U.S. Pat. No. 6,211,592 proposes two types of structures in which the fixed shaft has a single radial bearing and a single thrust bearing. One of the structures employs herringbone grooves for single radial bearing and single thrust bearing. The other one employs an asymmetric herringbone groove and a spiral groove for single radial bearing and single thrust bearing respectively.

The former structure still has the possibility of leakage of the lubricating fluid in view of machining imperfections at the mass production stage. The latter structure is less likely to cause the leakage of the lubricating fluid, though it cannot produce enough rotational moment that is necessary to maintain low non-repetitive runout during rotation.

The structure proposed in Japanese Unexamined Patent Application Publication No. 2004-173377 looks good in sealing the lubricating fluid. Nevertheless, the upper and lower asymmetric herringbone grooves have their asymmetric portions at the top and bottom ends, respectively, in such directions as to press the lubricating fluid toward each other. This decreases the effective radial bearing space. Another concern lies in that the top end of the radial bearing theoretically has an unlubricated area and there is no means to prevent or to remove air bubbles entering into.

The tapered seal structure widely used in the lubricating fluid sealing structures of the fluid dynamic bearing motors also puts a strong constraint on low-profile HDDs.

The tapered seal is a method of sealing which utilizes the surface tension of the lubricating fluid. It is generally desirable that the tapered seal have an opening angle of 10 degrees or less, in view of sealing strength.

The tapered seal appropriately has a maximum gap of 0.3 millimeters or so. Even if the dimensional precision of the individual parts are increased to suppress the maximum gap to 0.2 millimeters, the tapered seal has a total length of 1.1 millimeters or more, given the opening angle of 10 degrees.

It can be said that, in order to achieve an HDD fluid dynamic bearing motor having a thickness of no greater than 3 millimeters or so, compromises must be made in various respects—including the sealing of the lubricating fluid—despite an awareness of inadequacies.

### SUMMARY OF THE INVENTION

Thus, it is an object of the present invention to provide a fixed shaft type fluid dynamic bearing motor with its shaft attached or fixed at its both ends, with a reliable lubricating fluid sealing structure in which the bearing is open at both the upper and lower ends and ensuring highly precise rotational function.

Another object of the present invention is to provide a fluid dynamic bearing structure suitable for use in low profile motor for driving a few magnetic disk or the like at high precision.

A further object of the present invention is to provide a fluid dynamic bearing motor that has a single conical bearing surface, and suitable for low profile recording disk drive.

Yet further object of the invention is to provide a fluid dynamic bearing motor which has a cylindrical radial bearing and single thrust bearing, and suitable for low profile recording disk drive.

These and other objectives of the invention are achieved by a fixed shaft type fluid dynamic bearing motor according to the present invention. It comprises at least: a fixed shaft; a rotary portion including a sleeve which is rotatably fitted on the shaft with a small gap therebetween; an annular member fixedly provided to oppose a lower portion of the sleeve with a gap; a lubricating fluid lying in the gaps between the sleeve and the shaft, and between the sleeve and the annular member continuously, and having at least two interfaces with air near the top end of an inner periphery of the sleeve and around the lower part of the sleeve; and magnetic means for generating a magnetic attractive force in the axial direction between the shaft and the sleeve, a group of dynamic pressure generating grooves formed on either of the confronting surfaces of the sleeve and the shaft to support the rotary portion in a floated condition by the magnetic attractive force and an axial load due to pressure partially increased in the fluid by the grooves, the grooves being asymmetric herringbone grooves or spiral grooves to pump upward toward the upper end of the inner circumference of the sleeve, the fluid lying between the sleeve and shaft while the sleeve is rotating, and a channel formed in the sleeve and having an intake portion near the top end of the inner periphery of the sleeve and an outlet portion near the periphery of the bottom end of the sleeve, the intake portion being located radially inside the outlet portion, the channel continuously extending from the intake portion to the outlet portion, whereby the lubricating fluid is thrown out into the intake portion by centrifugal force near the top end of the inner periphery of the sleeve, and is conveyed from the intake portion to the outlet portion through the channel by centrifugal force and/or through a slanted channel in circumferential direction through the channel with the lubricating fluid being discontinuous.

According to an aspect of the present invention, the fluid dynamic bearing motor has one of the lubricating fluid interfaces with air at upper or lower side of the sleeve bottom level around the lower part of the sleeve. The fluid dynamic bearing motor which has the lubricating fluid interface at the lower part of the outer periphery of the sleeve enables thinner motor.

According to another aspect of the present invention, the fluid dynamic bearing motor realizes perfect sealing structure of the lubricating fluid by circulation of the lubricating fluid due to centrifugal force. During rotation of the motor, the lubricating fluid which is conveyed to the top of the sleeve inner surface by the pressure generating groove is thrown out into the channel in the sleeve. The channel desirably has a gap portion as small as the lubricating fluid can be retained therein by surface tension. At rest of the motor, the lubricating fluid is absorbed and retained in the channel. While the dimension of the gap of the channel may be as small as the lubricating fluid can be retained by surface tension, and the dimension varies depending on both the viscosity of the lubricating fluid and the surrounding materials. An appropriate value is no greater than 0.2 millimeters or so.

According to another aspect of the present invention, the fluid dynamic bearing motor has lubricating fluid pressure adjuster for adjusting the outward lubricating fluid pressure occurring in the channel around the channel outlet. During rotation of the motor, when the lubricating fluid pressure at the channel outlet which is caused by the centrifugal force and/or by slanted channel in circumferential direction is too large, it may force the lubricating fluid interface move outward and then may cause the fluid leakage. The lubricating fluid pressure adjuster eases and adjusts the fluid pressure in the channel and stabilizes the fluid movement for perfect sealing.

According to another aspect of the present invention, the fluid dynamic bearing motor has discontinuously filled lubricating fluid from the channel intake to the channel outlet. It makes easy that the fluid pressure diagram becomes continuous around the channel outlet so as to stabilize the fluid move.

According to yet another aspect of the present invention, the fluid dynamic bearing motor eliminates the need for a long tapered seal near the top end of the sleeve. At rest of the motor, most of the lubricating fluid is absorbed in the channel in the sleeve and during rotation, the lubricating fluid is thrown out into the channel near the top end of the sleeve by centrifugal force.

According to a further aspect of the invention, the fluid dynamic bearing motor effectively avoids leakage of the lubricating fluid. The lubricating fluid pumping capability of the dynamic-pressure generating groove, toward the top end of the sleeve is set sufficiently higher to compensate for such problems as imperfections in the dynamic-pressure generating groove, and the tilt of the gap in which the dynamic-pressure generating groove lies.

In a further aspect of the invention, the fluid dynamic bearing motor also has the function of removing air bubbles in the lubricating fluid. The lubricating fluid is influenced by the centrifugal force and is thrown out into the channel near the top of the sleeve inner surface. Meanwhile, the bubbles are released to the air since no centrifugal force acts thereon.

According to an aspect of an embodiment of the invention, the sleeve is composed of an outer barrel member and inner barrel member fixedly fitted in the outer barrel member with the channel being formed therebetween. Accordingly, it is easier to define the dimensions of the gap of the channel precisely and to control cross-sectional shape of the gap of the channel.

According to another aspect of the embodiment, the fluid dynamic bearing motor includes the fixed shaft of a conical or truncated conical shape with its diameter reducing toward the top end. The sleeve has a conical concave opening to fittingly receive the shaft. One or more sets or groups of dynamic-pressure generating grooves are formed on either of the shaft and the sleeve, with at least one of the dynamic-pressure generating grooves having capability of pumping the lubricating fluid toward the top end of the sleeve. This type of motor is suited for low profiles while securing the space for the dynamic-pressure generating grooves.

According to yet another aspect of the embodiment, the fluid dynamic bearing motor includes a fixed shaft of a cylindrical shape and a sleeve has a cylindrical opening to rotatably and fittingly receive the shaft. The sleeve opposes the annular member at its bottom end orthogonal to the shaft. Dynamic-pressure generating grooves are formed on either one of the outer periphery of the shaft and the inner periphery of the sleeve, and either one of the annular member and the bottom end of the sleeve, respectively. At least the dynamic-pressure generating groove formed on either the lower end of the sleeve or the surface opposing thereto is formed as an asymmetric herringbone groove or a spiral groove having capability of pumping the lubricating fluid radially inward.

According to still another aspect of the embodiment, the fluid dynamic bearing motor facilitates control of the amount of lubricating fluid to be filled into the bearing and also eliminates the impacts on rotational balance ascribable to uneven distribution and oscillation of the lubricating fluid. The intake of the channel lies radially inside the outlet of the channel, and little lubricating fluid resides within the channel during rotation. The channel is occupied mostly by air, and slightly by the lubricating fluid to flow.

### BRIEF DESCRIPTION OF THE DRAWINGS

In the accompanying drawings:

FIG. 1 is a vertical sectional view of a fixed shaft type fluid dynamic bearing motor which is a first embodiment of the present invention;

FIG. 2 is an enlarged perspective view of inner and outer cylindrical or barrel members which compose a sleeve shown in FIG. 1;

FIG. 3 is an enlarged vertical sectional view of the bearing part of FIG. 1;

FIG. 4 is an enlarged vertical sectional view of the bearing part of FIG. 1;

FIGS. 5(a), 5(b) illustrate in enlarged modeled forms the portion around the channel outlet and sleeve bottom of FIG. 1 and the lubricating fluid pressure diagram;

FIG. 6 is a vertical sectional view of a fluid dynamic bearing motor which is a second embodiment of the present invention;

FIG. 7 is an enlarged vertical sectional view of the bearing part of FIG. 6;

FIG. 8 is a vertical sectional view of a fluid dynamic bearing motor which is a third embodiment of the present invention;

FIGS. 9(a) and 9(b) are enlarged views of the bearing part of FIG. 8, showing the configuration of grooves which constitute a channel;

FIG. 10 is an enlarged view showing the configuration near the periphery of the bottom end of the sleeve of FIG. 8; and

FIG. 11 is an enlarged perspective view of inner and outer cylindrical or barrel members which compose a sleeve shown in FIG. 8;

FIGS. 12(a), 12(b) illustrate in enlarged modeled forms the portion around the channel outlet and sleeve bottom of FIG. 8 and the lubricating fluid pressure diagram;

FIGS. 13(a) and 13(b) are sectional views of a low-profile recording disk drive which is a fourth embodiment of the present invention.

### DETAILED DESCRIPTION OF THE PREFERRED EMBODIMENTS

Hereinafter, embodiments, operating principles of a fixed shaft type fluid dynamic bearing motor according to the present invention will be described with reference to the drawings.

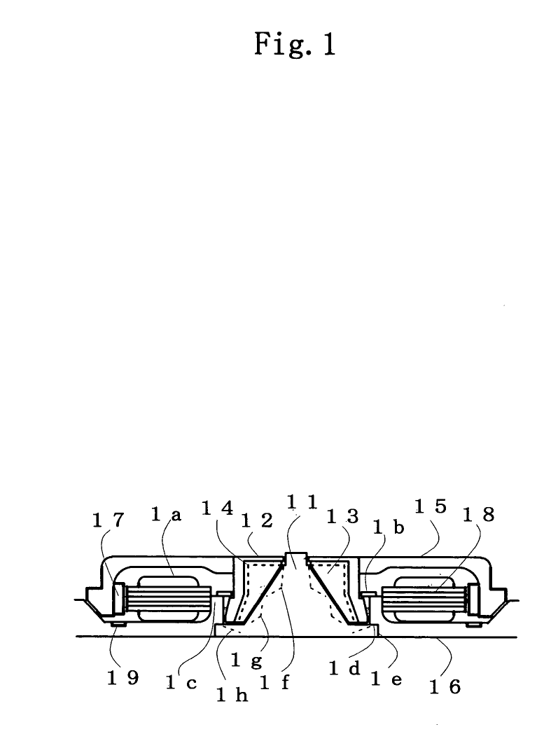

FIG. 1 is a vertical sectional view of a fixed shaft type fluid dynamic bearing motor which is a first embodiment of the present invention. A fixed shaft (hereinafter, referred to as a conical shaft 11 or a shaft 11) includes a truncated cone shape side wall diminishing its diameter toward an end of the shaft. A sleeve is composed of an outer member 12 and an inner member 13. The inner member 13 has an inner wall forming a conical concavity accommodating the shaft 11 and surrounding the side wall, the inner wall opposing the wall of the shaft 11 with a clearance. The shaft 11 is positioned to a base plate 16 by using its radial side 1e at the bottom end, and is fixed to the base plate 16 with its axial side 1d being secured with a suitable adhesive strength.

To attract the rotating part, including the outer member 12 and the inner member 13, magnetically along the axial direction, magnetic pieces 19 are embedded in the base plates 16 so as to face rotor magnets 17. The numerals 15, 18, and 1a represent a hub which supports one or more magnetic disks, a stator core, and a coil, respectively. An annular member 1c, confronting to the lower periphery of the outer member 12, is formed on a part of the base plate 16.

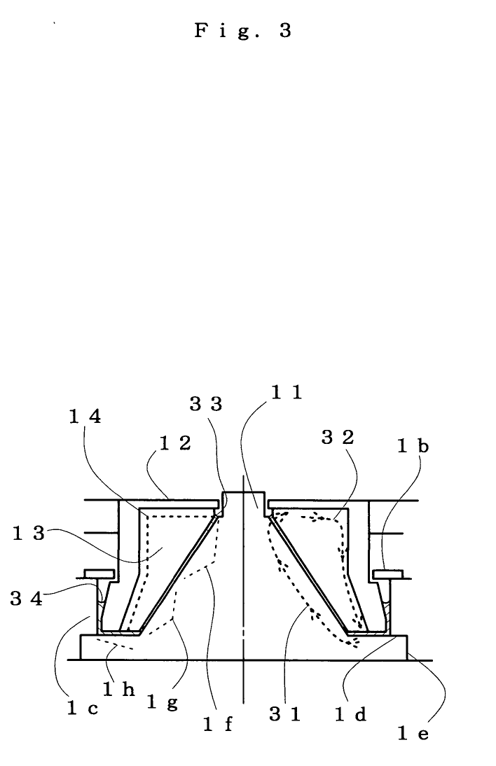

A lubricating fluid is continuously filled into the gap between the shaft 11 and the inner member 13, and the gap between the periphery of the outer member 12 and the annular member 1c. As shown in FIG. 3, the interfaces 33, 34 of the lubricating fluid with the air lie near the top end of the inner member 13 and on the periphery of the outer member 12 respectively.

The numeral 1b represents stoppers for regulating the amount of axial movement of the rotating part. The stoppers are fixed to the top end of the annular member 1c and engaged with a stepped portion on the periphery of the outer member 12.

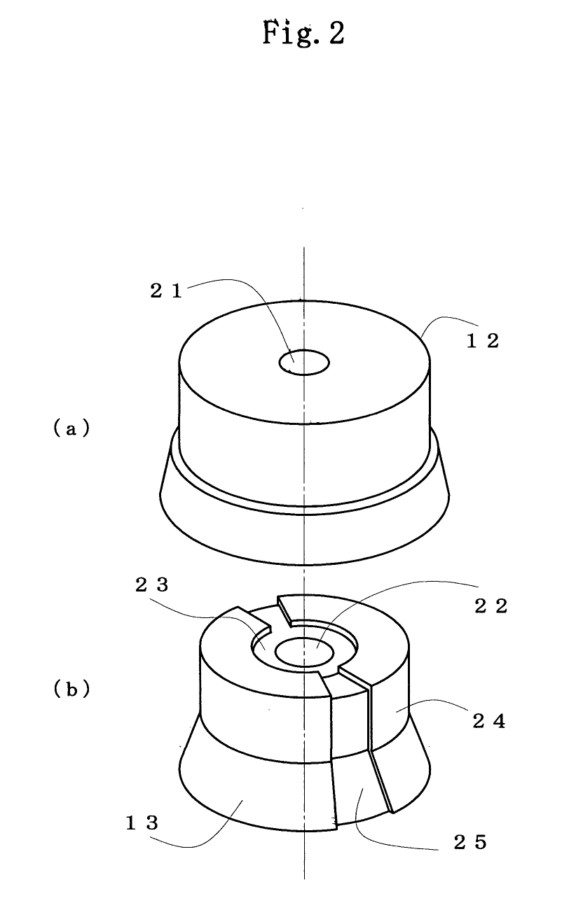

FIG. 2 is a perspective view of the outer member 12 and the inner member 13 that constitute the sleeve of the fluid dynamic bearing motor shown in FIG. 1. FIG. 2(a) and in FIG. 2(b) illustrate the outer member 12 and the inner member 13 respectively.

The outer member 12 is formed by press molding from Aluminium plate. And the inner member 13 is machined from SUS material. Two radial direction grooves for corresponding to the channel and a circular groove for corresponding to inlet portion of the channel are formed by machining on the surface of the inner member 13. The numerals 21, 22 represent an opening of the outer member 12, a hole that the shaft 11 will locate in respectively. And the numeral 24 represents outer surface of the inner member 13 except the radial direction groove 25.

The outer surface of the inner member 13 is fitted to the inner surface of the outer member 12 and fixed by bonding at the outer surface 24 of the inner member 13. The opening 21 diameter of the outer member 12 is smaller than that of the hole 22 of the inner member 13.

The circular and radial direction grooves 23, 25 are given a depth of, for example, around 50 micrometers so that the formed channel 14 has the capability of retaining the lubricating fluid by surface tension. The channel 14 is formed by the circular and radial direction grooves 23, 25 on the outer surface of the inner member 13, setting of the channel 14 gap dimension is easy. And also it is easy to realize various shape of channel cross section, for example, a rectangular shape shown in FIG. 2, and a crescent shape which has wide and narrow gap part.

The inner member 13 can be fabricated by molding of sintered material or resin also. In that case, the circular and radial direction grooves 23, 25 are formed by molding die at the same time, production cost will be reduced. Also, when the outer member 12 is formed by press molding, pits and projections may be formed simultaneously in and on the inner periphery of the outer member 12 to constitute the channel 14.

FIG. 2 shows the sleeve composition which has the conical bearing surface. Same sleeve composition is applicable for the bearing sleeve which has cylindrical bearing surface shown later.

Herringbone grooves 1f and 1g for generating dynamic pressures, are formed on the surface of the inner member 13 confronting to the surface of the shaft 11. The outer herringbone groove 1g is formed asymmetrically so that it pumps the lubricating fluid toward the top end of the sleeve against centrifugal force. In order to provide the objective function of the present invention, the inner dynamic-pressure generating groove may also be given a lubricating fluid pumping capability. Nevertheless, this still leaves the possibility of negative pressure occurring between the dynamic-pressure generating grooves. In the presence of a plurality of dynamic-pressure generating grooves, it is desirable that the outermost dynamic-pressure generating groove have a lubricating fluid pumping capability so that it presses the lubricating fluid for circulation. Numeral 1h designates a pump-in spiral groove which contributes to the lubricating fluid sealing.

FIG. 3 is an enlarged view of the bearing part of the fluid dynamic bearing motor shown in FIG. 1. Description will now be given of the operating principle. For convenience of understanding, FIG. 3 shows the channel 14 and the herringbone grooves 1f and 1g in the left half alone, while the directions of movement 31 and 32 of the lubricating fluid are shown by dotted lines in the right half. The numerals 33, 34 represent upper and lower lubricating fluid interfaces with air respectively.

The herringbone grooves are each made of a pair of spiral grooves for pumping the lubricating fluid toward each other. When the pumping capabilities of the lubricating fluid are configured unevenly, these spiral grooves exert the lubricating fluid pumping capability in one direction as an asymmetric herringbone groove. The herringbone groove 1g is set to have a lubricating fluid pumping capability directed radially inward, i.e., toward the top end of the sleeve.

When the inner member 13 and the outer member 12 are rotated, the herringbone grooves 1f and 1g increase the pressure of the lubricating fluid locally near their respective centers, thereby supporting the inner member 13 and the outer member 12 without contact.

Meanwhile, the herringbone groove 1g, having the asymmetric configuration, pumps the lubricating fluid toward the top end of the sleeve. The lubricating fluid thus flows in the direction shown by the dotted line 31, and is thrown out into the channel 14 by centrifugal force acting on the lubricating fluid near the top end of the inner member 13—the intake portion. The lubricating fluid in the channel 14 is further accelerated by centrifugal force, and guided along the inner periphery of the outer member 12 to an outlet portion, or to near the periphery of the bottom end of the outer member 12. The dotted line 32 shows the direction of flow of the lubricating fluid within the channel 14.

Near the top end of the sleeve where the leakage of the lubricating fluid is the most probable, the lubricating fluid is thrown out into the channel 14 by the centrifugal force acting directly on the lubricating fluid, and thus is prevented from leakage completely.

The foregoing structure for sealing the lubricating fluid also has the function of removing air bubbles. More specifically, if bubbles exist between the shaft 11 and the inner member 13, they are conveyed to near the top end of the sleeve by the flow of the lubricating fluid shown by the dotted line 31. In the intake portion, the lubricating fluid experiences the centrifugal force and is thrown out as shown by the dotted line 32. Meanwhile, the bubbles are released to the air since no centrifugal force acts thereon.

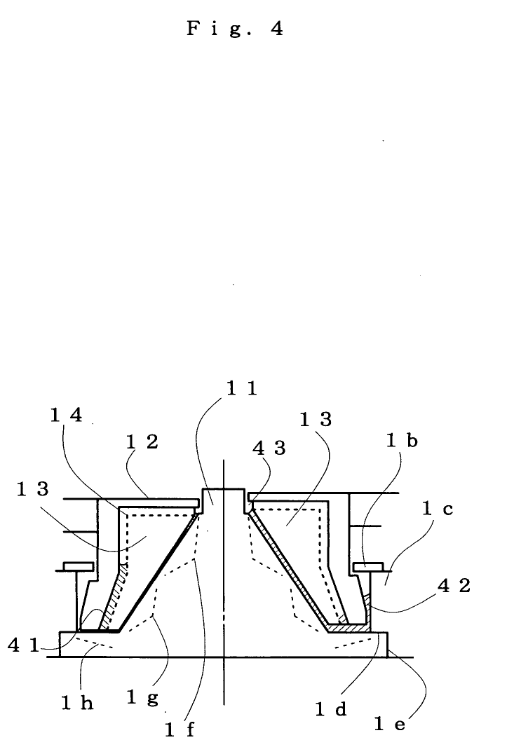

The behavior of the lubricating fluid at rest, and during rotation, will be described further with reference to FIG. 4. The left half of the diagram shows the state at rest, in which part of the inner member 13 is in contact with the shaft 11. The right half shows the state of during rotation, in which the inner member 13 floats without contact with the shaft 11.

What is worth noting in the left and right halves of FIG. 4 is the positions of the lubricating fluid. In the left half of the diagram which shows the state at rest, the lubricating fluid lies only in the channel 14 (designated by the numeral 41) and between the shaft 11 and the inner member 13. In the right half of the diagram which shows the state of during rotation, the lubricating fluid lies between the shaft 11 and the inner member 13, and between the outer member 12 and the annular member 1c (designated by the numeral 42).

The gap inside the channel 14 is as small as 50 micrometers or so. When at rest, the lubricating fluid lying between the outer member 12 and the annular member 1c, i.e., in a gap greater than the gap, is absorbed through the outlet portion. During rotation, the lubricating fluid is supplied from the channel 14 to between the outer member 12 and the annular member 1c, and to between the shaft 11 and the inner member 13, by centrifugal force. Consequently, near the top end of the sleeve, if the gap of the space 43 formed by the three members (the outer member 12, the inner member 13, and the shaft 11) is set greater than the gap that constitutes the channel 14, the lubricating fluid at rest is drawn into the channel 14 by surface tension and is no longer present in the foregoing space 43.

During rotation, the lubricating fluid is thrown out into the channel 14 by centrifugal force, and is no longer present in the foregoing space 43 again. This allows effective sealing of the lubricating fluid, with an axial space shorter than in conventional tapered seal structures.

If the channel 14 is made of a single small hole, the mixing of bubbles can make the lubricating fluid difficult to absorb at rest. In the present embodiment, the channel 14 is made of a plurality of grooves formed in the surface of the inner member 13, and thus is less susceptible to bubbles. In addition, when the cross sections of the grooves constituting the channel 14 are tapered so that the gaps vary gradually, bubbles are released with the areas of greater gaps acting as ventilation portions. This eliminates the possibility of bubble-related problems also.

Since the sleeve is composed of the inner member 13 and the outer member 12, it is easy to adjust the sectional configuration of the grooves that constitute the channel 14. The amount of the lubricating fluid to be drawn into the channel 14 at rest depends on the capacity of the channel 14. The volume of the channel 14 can be adjusted to alter the amount of the lubricating fluid to reside between the outer member 12 and the annular member 1c at rest (designated by the numeral 42).

The amount also depends on the gap inside the channel 14, and the gap between the outer member 12 and the annular member 1c. At the start of rotation, the lubricating fluid is supplied from the channel 14, yet with some time delay which might cause insufficient lubrication. Thus, the foregoing size specifications are adjusted so that an appropriate amount of lubricating fluid always resides between the outer member 12 and the annular member 1c, even at rest. In order to establish a setting that does not allow absorption of the lubricating fluid into the channel 14 at rest, the gap constituting the channel 14 is set so large that it is difficult to retain the lubricating fluid by surface tension, e.g. a value such as 0.5 millimeters or so.

The opening diameter in the top end of the outer member 12 is smaller than the diameter of the inner periphery of the inner member 13. The top end of the outer member 12 with small opening diameter not only promises the operation of damming up lubricating fluid that flows along the inner periphery of the inner member 13 during rotation, but also ensures the provision of perfect leakage prevention since the lubricating fluid is thrown out to the channel 14 before reaching the top end of the outer member 12.

The lubricating fluid at rest is retained by the channel 14, and the interface between the lubricating fluid and the air lies in the intake portion. The top end of the outer member 12 with small opening diameter keeps the interface of the lubricating fluid being positioned away from the exterior to the interior of the motor, thus playing a significant role in reducing the possibility of leakage.

Furthermore, the reduced gap between the opening in the top end of the outer member 12 and the shaft 11 provides the effect that the vapor pressure of the lubricating fluid within the space 43 is increased to suppress the evaporation of the lubricating fluid.

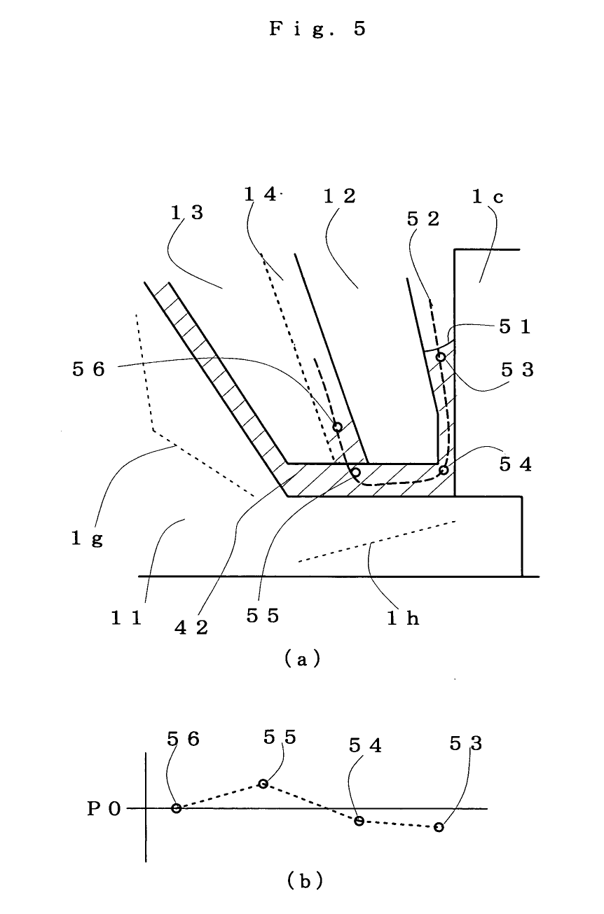

The lubricating fluid in the channel 14 is pressed outwardly by the centrifugal force and/or by the slanted channel in circumferential direction. The spiral groove 1h is applied as the lubricating fluid pressure adjuster for adjusting the fluid pressure occurring in the channel. While the spiral groove 1h lies between the channel outlet and the interface 51 with air on the lower portion of outer periphery of the sleeve. Along the dotted line 52, lubricating fluid pressure diagram is shown in FIG. 5(b). The horizontal axis indicates the location of points on the dotted line 52, and the vertical axis indicates the lubricating fluid pressure referring P0, the atmospheric pressure.

The fluid pressure at the point 53 inside of the interface 51 is lower than P0 the atmospheric pressure, and the fluid pressure at the point 54 is slightly higher than that by the centrifugal force. Then the fluid pressure at the point 55 is increased from the pressure at the point 54 by the spiral groove 1h. The lubricating fluid stays in the channel around the outlet and the fluid is flowing into its top end. So the pressure at the point 56 the upper end of the fluid in the channel almost equals P0 because there is no apparent meniscus, and the pressure from the point 56 towards the point 55 is increased by the centrifugal force.

The fluid pressure should be continuous as shown in FIG. 5(b) during rotation. When the quantity of the lubricating fluid at outer periphery of the sleeve increases, the interface 51 moves outward, and then the fluid pressure at the point 53 becomes higher towards P0 because that a radius of the interface 51 curve becomes larger. While the lubricating fluid in the channel increases, the pressure difference between the points 56 and 55 also becomes larger. Accordingly, the quantity of the lubricating fluid around the channel outlet is properly divided in the channel and at outer periphery of the sleeve as the fluid pressure is continuous as shown in FIG. 5(b).

When the spiral groove 1h is not allocated, the stabilization condition of the fluid around the channel outlet is that the location of the point 54 is radially outward from the point 53 as the pressure at the point 54 becomes close to the P0 by the centrifugal force. Then there exist strict constraints about the outer member 12 shape and dimensions. The present embodiment applying the spiral groove 1h between the channel outlet and the fluid interface 51 makes the design flexible.

The fluid dynamic bearing motor of the present invention, has discontinuously filled lubricating fluid from the channel intake to the channel outlet. It makes the fluid pressure balance around the channel outlet easy and contributes to the stable fluid sealing. In case that there is continuously filled lubricating fluid in the channel, it is hard to balance the fluid pressure generated by the grooves and the centrifugal force with the pressure near the fluid interface during rotation.

The magnetic pieces 19 are made of a magnetic substance such as silicon steel plates, ferrite, and permalloy. The magnetic piece 19 generates a magnetic attractive force between the rotating part and the stationary part, in cooperation with the rotor magnets 17.

The rotor magnets 17 are magnetized so as to alternate in magnetization, and thus cause eddy currents in the magnetic piece 19 during rotation. Permalloy or ferrite is less susceptible to eddy currents than silicon steel plates, and thus is suitable for high speed rotation.

If the magnetic attractive force resulting from the magnetic piece 19 alone is insufficient, the stator core 18 and the rotor magnets 17 may be displaced axially relative to each other to generate additional magnetic attractive forces.

The rotating part is floated and supported at the position where the axial components of the load capacities created by the herringbone grooves 1f and 1g, and the magnetic attractive force are balanced. The load from the weight of the rotating part on the bearing part varies, while the amount of float of the rotating part varies depending on the orientation of the motor in use, such as being erect, inverted, or sideways. The magnetic attractive force is set at around three to five times the total weight of the rotating part including the outer member 12, the inner member 13, the hub 15, the rotor magnets 17, and the magnetic disk or the like to be mounted thereon. This applies an axial downward load above a certain level irrespective of the orientation of the HDD, whereby the present fluid dynamic bearing can achieve low non-repetitive runout during rotation.

The foregoing has dealt with the case where the dynamic-pressure generating grooves are composed of the two herringbone grooves formed in the conical surface of the shaft 11. It is possible, however, for only a single series of asymmetric herringbone groove formed in the conical surface of the shaft 11 to float and support the rotating part, and to achieve low non-repetitive runout during rotation. In this case, a fluid dynamic bearing motor of lower profile can be constructed. The structure of the bearing part and the principle of operation in case of a single herringbone groove formed in the conical surface are disclosed in detail in a U.S. Pat. No. 6,686,674 that is owned by the same applicant of the present application, and disclosure of the patent is incorporated herein by reference.

In the present embodiment, the channel 14 is formed as the gap between the inner member 13 and the outer member 12. Nevertheless, the inner member 13 of the sleeve may be made of a porous material having a number of small gaps so that the small gaps form the channel 14. A sintered alloy material may be filled into the outer member 12 to form the inner member 13, and to form the herringbone grooves 1f and 1g simultaneously.

Since small gaps also exist in the surface of the area where the herringbone grooves 1f and 1g are formed, the lubricating fluid might permeate into the inner member 13 through those gaps in the surface, possibly causing shortage of the lubricating fluid in the herringbone groove 1f. In this case, the small gaps in the surface of the inner member 13, excluding near the interface with the outer member 12, are filled with a resin having a high lubricity for caulking.

The novel lubricating fluid sealing structure, of which the structure and principle of operation have been described in the present embodiment, is characterized in that the axial space necessary near the top end of the sleeve can be made smaller. Referring to FIG. 4, the necessary axial space is the sum of the thickness of the outer member 12 and the axial length of the space 43 formed by the three members: the outer member 12, the inner member 13, and the shaft 11.

If the outer member 12 is formed by pressing or drawing a thin plate of 0.2 millimeters or so, and the latter dimension is set at 0.1 millimeters (which is greater than the gap of the channel 14, or 50 micrometers) then the entire lubricating fluid sealing structure can be formed in 0.3 millimeters. These values can also be reduced further, and it is possible to achieve a reliable lubricating fluid sealing structure with considerably smaller axial dimensions as compared to conventional tapered seals.

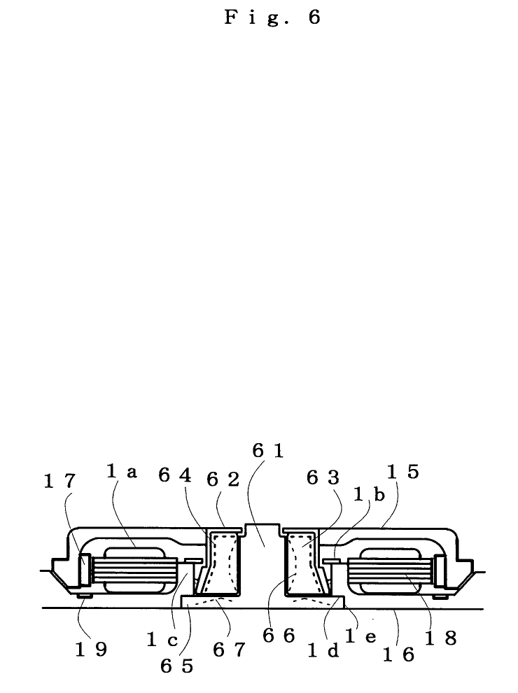

While the first embodiment has dealt with an example of a cone bearing, a second embodiment shown in FIG. 6 will deal with an example where the lubricating fluid sealing structure of the present invention is applied to a cylindrical shaft.

The sleeve, which rotatably fits to a T-shaped cylindrical shaft 61, is composed of an inner cylinder 63 and an outer cylinder 62 corresponding to an inner member 13 and an outer member 12 respectively in FIG. 1. A channel 64 is formed in the gap between the outer cylinder 62 and the inner cylinder 63. A lubricating fluid continuously lies between the shaft 61 and the inner cylinder 63 and between the outer cylinder 62 and an annular member 1c.

The inner periphery of the inner cylinder 63 is provided with a single herringbone groove 66, which constitutes a radial bearing. A flange 65 of the shaft 61 confronting the bottom end of the inner cylinder 63 is provided with an asymmetric herringbone groove 67 which has a radially inward lubricating fluid pumping capability against centrifugal force. This constitutes a thrust bearing. The annular member 1c which is a part of the base plate 16, and the flange 65 which is a part of the shaft 61 are corresponding to the annular member defined in the claim 1 and 2. The other parts are the same as in the first embodiment shown in FIG. 1. The same members will be designated by identical numerals.

As far as the combination of the dynamic-pressure generating grooves alone is concerned, the radial and thrust bearings are close to those of U.S. Pat. No. 6,211,592. There is a difference, however, in that the asymmetric herringbone groove 67 is arranged near the bottom end of the inner cylinder 63 to make the lubricating fluid flow toward the top end of the inner periphery of the inner cylinder 63.

In the case of U.S. Pat. No. 6,211,592, the individual herringbone grooves can cause flows of the lubricating fluid due to imperfections in mass production, possibly causing leakage of the lubricating fluid with a considerable probability. In the case of FIG. 6, on the other hand, the lubricating fluid sealing structure of the present invention is adopted to prevent the lubricating fluid from leaking.

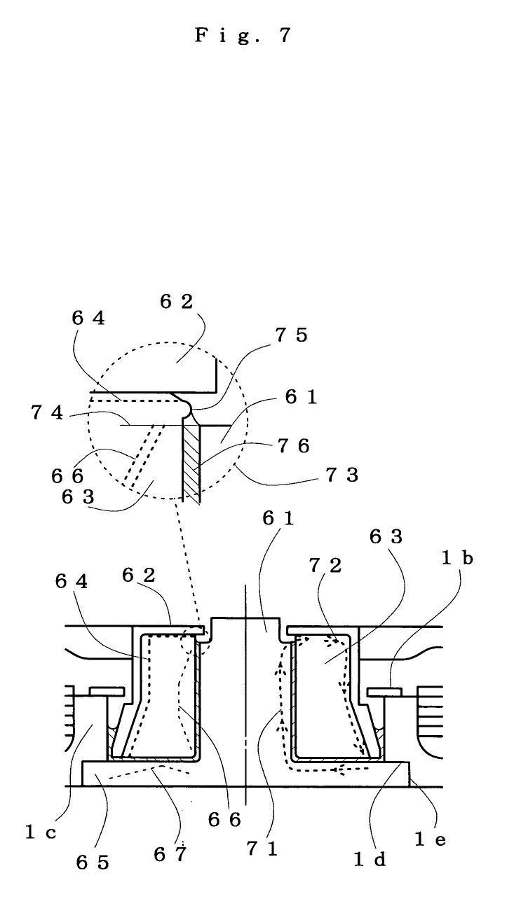

FIG. 7 is an enlarged view of the shaft 61 and in the vicinity of the sleeve of the fluid dynamic bearing motor shown in FIG. 6. The asymmetric herringbone groove 67 is provided with a lubricating fluid pumping capability sufficient to pump the lubricating fluid toward the top end of the inner cylinder 63 against centrifugal force.

The lubricating fluid is pumped from the periphery of the herringbone groove 67 to near the top end of the inner periphery of the inner cylinder 63, as shown by the dotted line 71. Near the top end of the inner periphery of the inner cylinder 63, the lubricating fluid is thrown out into the channel 64 by centrifugal force, and returns to near the periphery of the herringbone groove 67.

As in the first embodiment described in conjunction with FIGS. 3 and 4, the lubricating fluid is sealed effectively, and bubbles are separated by the same principle. The dotted lines 71 and 72 correspond to the dotted lines 31 and 32 of FIG. 3.

The structure near the top end of the sleeve is shown enlarged further in the circle shown by the dotted line 73. The numeral 74 designates the shoulder line of the shaft 61. The area below the numeral 74 is the area of the radial bearing. The top end of the herringbone groove 66 lies near the level of this numeral 74.

The numeral 75 represents an annular projection which is formed around the inner periphery of the inner cylinder 63. In FIG. 7, the annular projection is given a height (in the radial direction) of approximately one half of 2 micrometers (which is the gap width between the inner cylinder 63 and the shaft 61).

The lubricating fluid 76 pumped by the asymmetric herringbone groove 67 is thrown out to the channel 64 beyond this annular projection 75, whereby an accumulation of the lubricating fluid 76 is constantly formed near the top end of the herringbone groove 66. The annular projection 75 desirably has a height close to the gap between the inner cylinder 63 and the shaft 61. Greater heights have little further effect. Instead of forming the annular projection 75, the top end of the herringbone groove 66 may be extended to near the intake portion of the channel 64, with the effect of putting the lubricating fluid near the top end of the herringbone groove 66.

In FIGS. 6 and 7, the radial bearing is made with only a herringbone groove 66 in the inner periphery of the inner cylinder 63. It is possible to center the rotating part to the shaft 61, but not to generate a moment for restoring orientation when the rotating part tilts. In the present embodiment, the moment for restoring the orientation of the rotating part is generated by the asymmetric herringbone groove 67—the thrust bearing.

More specifically, when the rotating part tilts, the bottom end of the inner cylinder 63 also tilts to change the gap with the flange 65. In the vicinities of the areas where the gap varies in size, the asymmetric herringbone groove 67 increases the local pressure at its radial center by a degree inversely proportional to the gap. A moment for restoring the orientation of the rotating part occurs thus, and the orientation of the rotating part is restored. Having a single radial bearing alone, the present embodiment is suited to low-profile HDDs.

In the case of the fixed shaft structure as shown in FIG. 6, the shaft is usually pressed into the base plate, followed by adhesive bonding. In view of the fastening strength and the precision of the rectangularity between the two, an axial thickness of 1 millimeter or a little less is desirably secured for the fastening portion.

Suppose that the portion opposed to the bottom end of the inner cylinder 63, serving as the flange 65, is given a minimum necessary dimension of around 0.5 millimeters and is integrated with a shaft to form the T-shaped shaft 61 for use. Then, a radial bearing space of 0.5 millimeters or so can be managed.

This makes it difficult, however, to secure the fastening strength and the rectangularity between the T-shaped shaft 61 and the base plate 16. Thus, in FIG. 6, the position of the T-shaped shaft 61 with respect to the base plate 16 is regulated by the radial side 1e of the flange 65 of the T-shaped shaft 61. The adhesive bonding strength and the rectangularity are secured by the outer periphery 1d of the surface in which the thrust bearing is formed.

According to the present embodiment, the magnetic attractive force is balanced with the axial load capacity, which only a single thrust bearing generates by dynamic pressure. Nevertheless, this consequently causes the bottom end of the inner cylinder 63 to make contact and slide over the flange 65 under the magnetic attractive force when at the start of rotation, and at halt.

In the present embodiment, in order to avoid damage ascribable to the contact and slide, a solid lubricant comprising mainly molybdenum disulfide is applied to approximately 10 micrometers on the bottom end of the inner cylinder 63. Alternatively, a DLC film of 1 micrometer or so may be formed effectively as a solid lubricating film.

In another possible method, projections having a height of several micrometers may be formed in a circumferential configuration, or in a spot configuration on the bottom end of the inner cylinder 63 or part of the flange 65 so that the frictional force at the time of rotation is reduced for easier startup. This is already public knowledge in flying head technology, and description thereof will thus be omitted.

In the embodiment shown in FIGS. 6 and 7, the outlet of the channel 64 lies in the area of the asymmetric herringbone groove 67. The outer part of the asymmetric herringbone groove 67 from the channel 64 outlet has the same function of the spiral groove 1h in FIG. 1. And it contributes the fluid sealing stability. The operating principle is the same as explained referring FIG. 5.

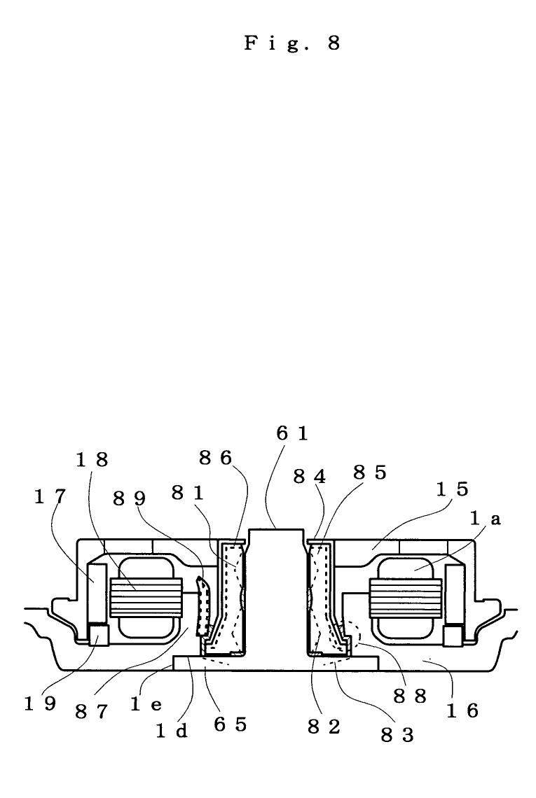

FIG. 8 shows a third embodiment. Like the second embodiment, this third embodiment will deal with an example of cylindrical shaft. Description will thus be concentrated on differences from the second embodiment shown in FIG. 6.

The sleeve, which rotatably fits to a T-shaped cylindrical shaft 61, is composed of an inner cylinder 85 and an outer cylinder 84. A channel 86 is formed in the gap between the outer cylinder 84 and the inner cylinder 85. That is, two herringbone grooves 81 and 82 are formed as radial bearings between the T-shaped shaft 61 and the inner periphery of the inner cylinder 85.

The lower herringbone groove 82 is formed asymmetric so as to have a downward lubricating fluid pumping capability. In addition, a pump-in spiral groove 83 is formed in the flange 65 of the shaft 61 opposed to the bottom end of the inner cylinder 85.

During rotation, the asymmetric herringbone groove 82 and the spiral groove 83 press the lubricating fluid toward each other to increase the pressure of the lubricating fluid at the bottom end of the inner cylinder 85. The rotating part is supported without contact at the point where the resulting axial load capacity and the magnetic attractive force are balanced.

When an outer cylinder 84 and the inner cylinder 85 constituting the sleeve are rotated, the pressure of the lubricating fluid is increased locally by the herringbone grooves 81, 82 and the spiral groove 83, whereby the outer cylinder 84 and the inner cylinder 85 are supported without contact. Here, the herringbone groove 82 is configured to have the downward lubricating fluid pumping capability, and the lubricating fluid pumping capability of the herringbone groove 82 is set smaller than that of the spiral groove 83 at a predetermined rotational speed. The lubricating fluid thus keeps flowing across the herringbone grooves 82 and 81 toward the top end of the inner cylinder 85.

The lubricating fluid is thrown out to a channel 86 formed in the gap between the outer cylinder 84, and the inner cylinder 85, by centrifugal force. The lubricating fluid is further conveyed to near the inner periphery of outer cylinder 84, and finally reaches the outlet portion near the lower periphery of the outer cylinder 84.

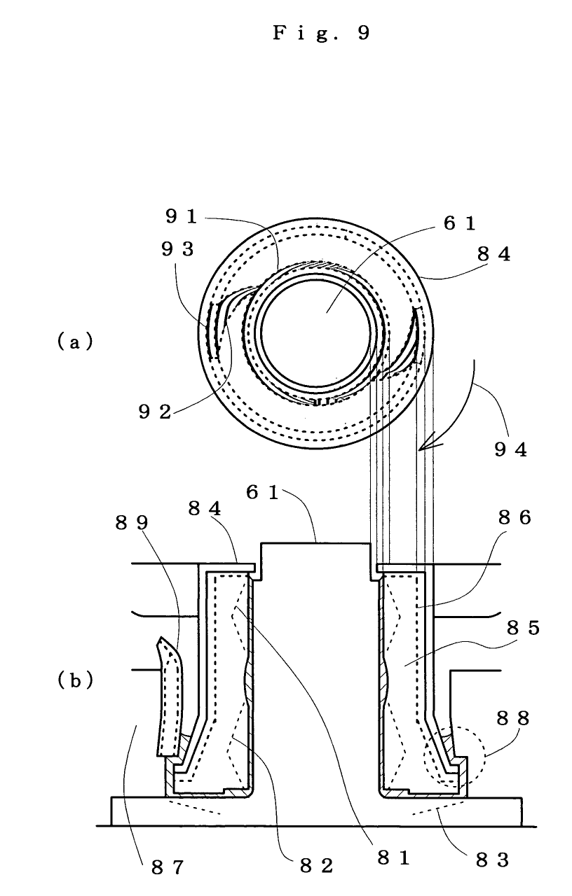

The channel 86 formed between the outer cylinder 84 and the inner cylinder 85 has a shape different from in the other embodiments. More specifically, as shown in FIG. 9(a), the intake portion (corresponding to the circular groove 23 shown in FIG. 2) of the channel 86 for opening to the inner periphery of the inner cylinder 85 is configured to open around the inner periphery of the inner cylinder 85 as shown by the numeral 91. The channel 86 extending outward from the intake portion 91 is made of pump-out grooves 92 of spiral shape.

The numeral 93 represents grooves formed in the outer periphery of the inner cylinder 85, and the inner periphery of the outer cylinder 84, from above to below so as to be continuous to the grooves 92 of spiral shape which forms the slanted channel in circumferential direction. The numeral 94 represents the direction of rotation of the rotating part.

During rotation, the lubricating fluid is conveyed along the inner periphery of the inner cylinder 85 toward the top end, and thrown out into the intake portion 91 by centrifugal force. The lubricating fluid is further driven radially outward by centrifugal force, and the spiral grooves 92.

The bearing gap (flying height) between the inner cylinder 85 and the flange 65 is still small at the beginning of the rotation. The lubricating fluid pumping capability of the spiral groove 83 is large at the small bearing gap and also the centrifugal force that acts on the fluid at the top of the inner cylinder 85 is still small, then the pumped lubricating fluid tends to be accumulated at the channel 86 intake and there is some possibility of leakage. The grooves 92 of spiral shape transfer the fluid at the channel 86 intake outwardly and prevents the fluid leakage.

In the grooves 92 and 93 constituting the channel 86, there exist the lubricating fluid to be conveyed, the air, and the vapor of the lubricating fluid. These are driven radially outward by the spiral grooves 92. This substantially increases the inward channel resistance to air and vapor from the lubricating fluid, whereby the vapor pressure of the lubricating fluid in the grooves 92 and 93 is increased to suppress further evaporation of the lubricating fluid.

While the grooves 92 and 93 have complicated shapes, they can be formed easily during the die forming of the inner cylinder 85, or the press molding of the outer cylinder 84, with no increase in cost.

Furthermore, the intake portion 91 of the channel 86 lying at the top end of the inner cylinder 85 is satisfactorily formed as a gap of several micrometers in the axial direction. The channel resistance to the air near the intake portion 91 can thus be increased to increase the vapor pressure of the lubricating fluid in the channel 86, composed of the grooves 92 and 93, thereby contributing to the suppression of evaporation of the lubricating fluid.

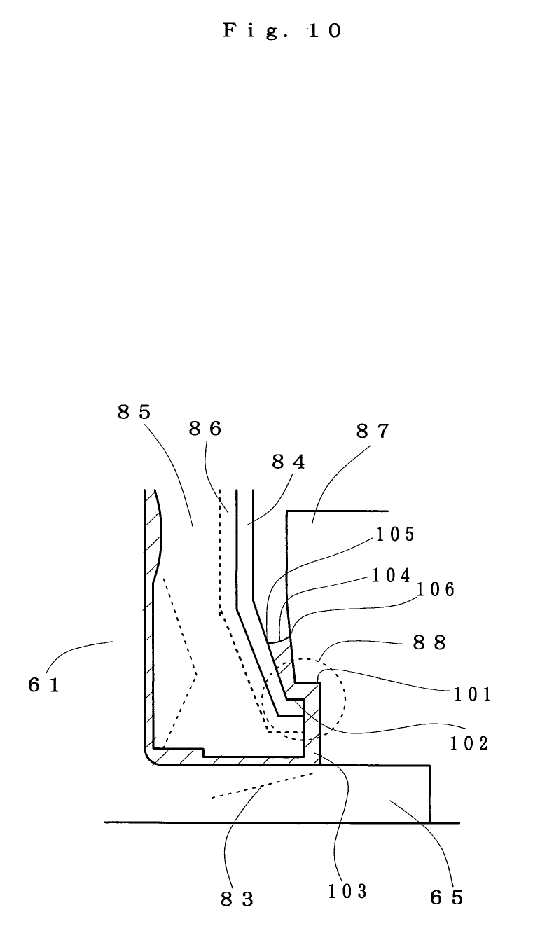

For the sake of regulation of the amount of axial movement of the rotating part, an engaging portion 88 is formed in an area where the lubricating fluid is in contact. As shown enlarged in FIG. 10, the lower periphery of the outer cylinder 84 reduces in diameter with an increasing distance from the bottom end to above, and the gap from the annular member 87 (corresponding to the annular member 1c shown in FIG. 1) is increased gradually to form a tapered seal portion.

In addition, a side 101 of the annular member 87, and a side 102 protruded from the periphery of the outer cylinder 84, are engaged to form an engaging portion. The inner periphery of the annular member 87 is slightly tilted toward the periphery of the outer cylinder 84. This tilt may be sharpened to engage with the tilt of the lower periphery of the outer cylinder 84 for the sake of a structure providing positional regulation. Even when the sleeve is moved upward by excessive impact and the engaging portion makes contact or slides, the presence of the lubricating fluid can avoid serious problems such as damage or the production of abrasive dust.

The peripheral portion of the spiral groove 83 is where negative pressure can easily occur during high speed rotation. Countermeasures will now be described with reference to FIG. 10.

While the spiral groove 83 pumps the lubricating fluid radially inward, the radially-outward centrifugal force acting on the peripheral portion can lower the pressure of the lubricating fluid to a negative pressure. This makes it easier for bubbles to reside. The numerals 105 represents an intersection of the outer cylinder 84 with the interface 104 between the lubricating fluid with the air, while the numeral 106 represents an intersection of the annular member 87 with the interface. The portion of the lubricating fluid interface 104 around the intersection 105 is moving rapidly with the outer cylinder 84, and the portion of the lubricating fluid interface 104 around the intersection 106 is at rest with the annular member 87. In the present embodiment, the spiral groove 83 is given an outer diameter greater than the outer diameter of the outer cylinder 84, i.e., it is arranged radially outside the high-speed flow side (105) of the interface 104 of the lubricating fluid 103.

Consequently, the centrifugal force acting on the lubricating fluid that is rotating and flowing at high speed is integrated along the surface of the outer cylinder 84. The pressure of the lubricating fluid reaches its maximum near the periphery of the bottom end of the inner cylinder 85. In this structure, the centrifugal force is then utilized to apply pressure to near the periphery of the spiral groove 83, thereby avoiding the occurrence of negative pressure.

Moreover, in the present embodiment, a hollow pipe 89 is positioned in the accumulation of the lubricating fluid between the outer cylinder 84 and the annular member 87, as shown in FIGS. 8 and 9, as means for facilitating the filling of the lubricating fluid.

The lubricating fluid sealing structure of the present invention has a perfect function for removing bubbles. It is therefore possible to complete the filling of the lubricating fluid by dropping the lubricating fluid in the atmosphere. Nevertheless, in the presence of such an engaging portion as shown by the numeral 88 as in the present embodiment, the lubricating fluid must be filled through the gap between the outer cylinder 84 and the annular member 87 after the bearing part is assembled. This is not easy when the gap is small.

In the present embodiment, at the time of assembly, the hollow pipe 89 is embedded so that an end thereof opens to the accumulation of the lubricating fluid between the outer cylinder 84 and the annular member 87. After the assembly of the bearing part is completed, the lubricating fluid is filled through the hollow pipe 89. The hollow pipe 89 is closed up to complete the filing step. The hollow pipe 89 may be made of such a material as metal, resin, and glass. The means for closing the end include melting and squeezing.

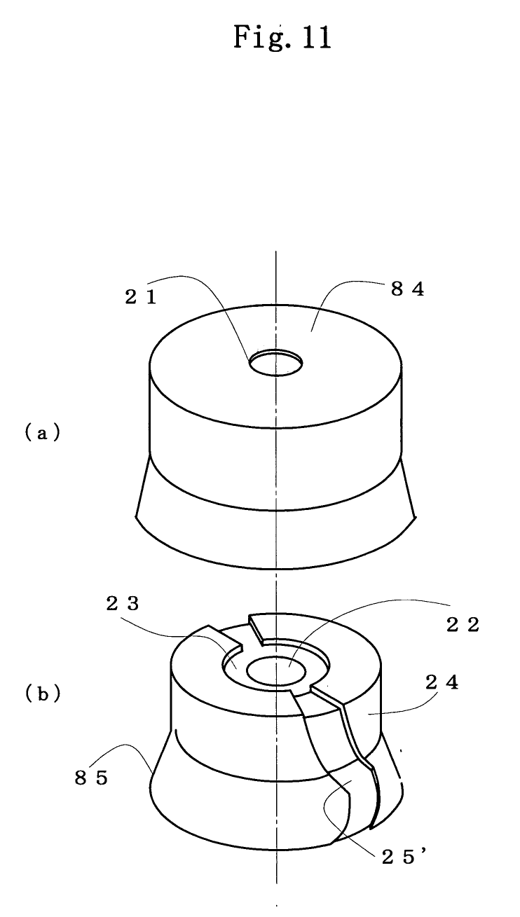

FIG. 11 shows a perspective view of the inner and outer cylinder. A groove 25′ formed on the surface of the inner cylinder 85 is different from the groove 25 in its shape. The groove 25 is linear and the groove 25′ is spiral shape. An upper part of the groove 25′ is pump-out type that presses the fluid downward, and a lower one is pump-in type that presses the fluid upward during rotation. The channel 86 may have difficulty to have gradient to be able to drive the lubricant downward by centrifugal force in the case of long sleeve, upper part of spiral groove 25′ can pump the lubricant to downward instead of the centrifugal force.

In the grooves 25′ constituting the channel 86, there exist the lubricating fluid to be conveyed, the air, and the vapor of the fluid. These are driven downward by the upper part of the spiral grooves 25′ during rotation. This substantially increases the inward flow resistance to air and vapor from the fluid, whereby the vapor pressure of the fluid in the groove 25′ is increased to suppress further evaporation of the lubricating fluid. And the lower part of the groove 25′ is spiral shape that presses the fluid upwardly, the combination of two spiral grooves has function of the fluid pressure adjusting, and contributes the fluid sealing stability.

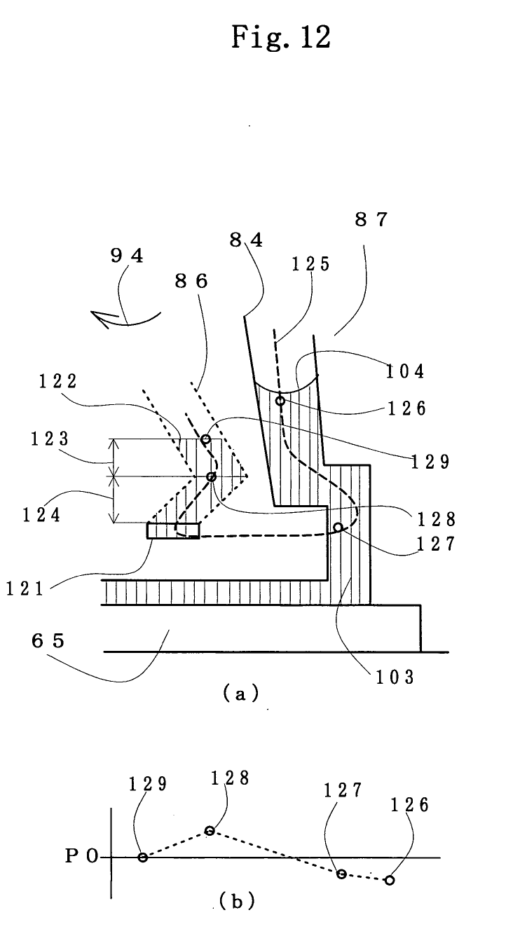

FIG. 12(a) and 12(b) show the enlarged view of an accumulation of the lubricating fluid of outer periphery of the sleeve and the channel close to its outlet, and the lubricating fluid pressure diagram. Numeral 103 indicates the lubricating fluid at the outer periphery of the sleeve, numeral 121 indicates the outlet of the channel 86, and numeral 122 indicates the lubricating fluid in the channel 86, respectively. Along the dotted line 125, the point 126 inside of the interface 104, the point 127 around the outlet 121, the point 128 at the folding corner of the channel 86, the point 129 at the top end of the fluid 122 are shown in FIG. 12(a). Fluid pressures at these points are indicated in FIG. 12(b). The horizontal axis means the location of points on the dotted line 125, and the vertical axis means the lubricating fluid pressure referring P0 the atmospheric pressure. Numeral 124 indicates the axial length of the fluid 122 between the outlet 121 and the channel 86 corner, numeral 123 indicates the axial length of the fluid 122 between the channel 86 corner and the top end of the fluid 122.

The fluid pressure at the point 126 inside of the interface 104 is lower than P0 the atmospheric pressure, and the fluid pressure at the point 127 is slightly higher than that by the centrifugal force. The fluid pressure at the point 128 is increased by the slanted channel 86. The pressure at the point 129 almost equals P0, and pressure difference from the point 129 towards the point 128 is increased by the slanted channel in circumferential direction during rotation.

The fluid pressure should be continuous as shown in FIG. 12(b) during rotation. Pressure difference between points 127 and 128 is proportional to the length 124, pressure difference between points 129 and 128 is proportional to the length 123. While the quantity of the lubricating fluid at outer periphery of the sleeve increases, the interface 104 moves outward, and then the fluid pressure at the point 126 becomes higher towards P0 because that a radius of the interface 104 curve becomes larger. Accordingly, the quantity of the lubricating fluid around the channel outlet 121 is properly divided in the channel and at outer periphery of the sleeve as the fluid pressure is continuous as shown in FIG. 12(b).

In the embodiment shown in FIGS. 8, 9, 10, 11 and 12, the slanted channel corresponding to the numeral 124 is applied as the lubricating fluid pressure adjuster for adjusting the outward/downward lubricating fluid pressure occurring in the channel around the channel outlet.

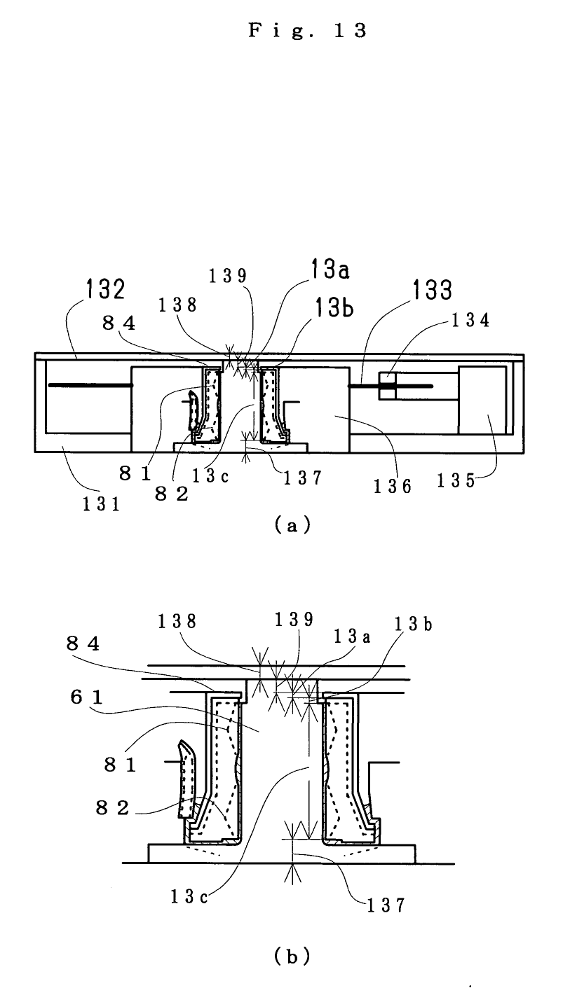

For a fourth embodiment of the present invention, description will be given of an example where a low-profile HDD is formed. FIGS. 13(a) and 13(b) show an example of configuration of the low-profile HDD which is formed by incorporating the third embodiment of the present invention, or the fluid dynamic bearing motor of the fixed shaft structure of FIG. 8.

The low-profile HDD shown in FIG. 13(a) has a fluid dynamic bearing motor 136 of fixed shaft structure which is formed on a case 131, or on the base plate 16. A magnetic disk 133 is loaded on the motor 136. An actuator 135 for positioning a magnetic head 134 at a predetermined position on the magnetic disk 133 is provided. A cover 132 is fixed to the case 131. The shaft 61 makes contact with the cover 132 from below, thereby supporting the cover 132. None of electronic circuits and filter mechanisms for controlling the environment inside the HDD is shown.

In FIGS. 13(a) and 13(b), the fluid dynamic bearing motor 136 is shown with the internal bearing alone. FIG. 13(b) shows an enlarged view. In the present embodiment, it is assumed that the magnetic disk has a diameter of 25 millimeters or so, and the low-profile HDD has a thickness of 2.5 millimeters or so.

Due to the limitation on the thickness of the HDD, bolts for fixing the shaft 61 to the cover 132 are omitted. The shaft 61 is used as a supporting column which makes contact with the cover 132 from inside, and avoids inward deformation of the cover 132. The numeral 138 designates the thickness of the cover 132, the numeral 139 the distance from the inside of the cover 132 to the surface of the sleeve, the numeral 13a the axial thickness of the outer cylinder 84, the numeral 13b the distance from the bottom of the outer cylinder 84 to the shoulder of the shaft 61 (the level of top end of the herringbone groove 81), and the numeral 137 the distance from the bottom of the case 131 to the bottom end of the herringbone groove 82. The numeral 13c designates the distance from the top end of the herringbone groove 81 (the shoulder of the shaft 61) to the bottom end of the herringbone grove 82, showing the length secured for the radial bearing part.

Suppose here that the dimensions designated by the numerals 138, 139, 13a, and 13b are set at 0.1 millimeters each, and the dimension designated by the numeral 137 is set at 0.5 millimeters. The total thickness of the HDD of 2.5 millimeters then allows 1.6 millimeters for the effective length 13c of the radial bearing part. Since it is enough to assign 0.7 millimeters or so to each of the herringbone grooves 81 and 82, the low-profile HDD having a thickness of 2.5 millimeters can be formed even if the asymmetric portion of the herringbone groove 82 is arranged in the middle.

The foregoing has shown that the fixed shaft type fluid dynamic bearing motor of the present invention is suited to achieving a low-profile HDD. This indicates the high potential of the present invention. When applied to an HDD having a sufficient thickness, the present invention realizes a fluid dynamic bearing motor having shaft vibrations significantly smaller than conventional structures.

In principle, the present invention is suitable for high speed rotations, and is suited to server-class HDDs of small sizes which require rotations as high as around 20,000 RPM.

In the present invention, a new lubricating fluid sealing method alternative to conventional tapered seals has been proposed, and the characteristics thereof have been described along with the principle of operation.

The embodiments have dealt with application examples such as a cone bearing and a cylindrical bearing which have a straight bearing surface. In addition thereto, structures having a curved bearing surface are also applicable.

Up to this point, the principle of operation and structure of the present invention have been described in conjunction with the embodiments. The foregoing embodiments are no more than a few examples given for the sake of describing the principle of operation of the present invention, and it is understood that modifications may be made to the materials, structures, and the like without departing from the spirit of the present invention, and the foregoing description by no means limits the scope of the present invention.

From the studies on the behavior of the lubricating fluid in fluid dynamic bearings, a fixed shaft type fluid dynamic bearing motor which has a low-profile and is free from the leakage of the lubricating fluid has been achieved. This motor is particularly suitable for a recording disk drive motor for high speed rotation in which low non-repetitive runout can be, and a low-profile recording disk drive whose case cover requires a supporting column.

The present application claims Convention priority based on a Japanese patent application 2004-196174, 2004-199022, 2004-227399 of which disclosure is incorporated herein by reference.

What is claimed is:

1. A fluid dynamic bearing motor comprising:
a fixed shaft;
a rotary portion including a sleeve which is rotatably fitted on the shaft with a small gap therebetween;
an annular member fixedly provided to oppose a lower portion of the sleeve with a gap;
a lubricating fluid lying in the gaps between the sleeve and the shaft, and between the sleeve and the annular member continuously, and having at least two interfaces with air near the top end of an inner periphery of the sleeve and around the lower part of the sleeve; and
magnetic means for generating a magnetic attractive force in the axial direction between the shaft and the sleeve,
a group of dynamic pressure generating grooves formed on either of the confronting surfaces of the sleeve and the shaft to support the rotary portion in a floated condition by the magnetic attractive force and an axial load due to pressure partially increased in the fluid by the grooves, the grooves being asymmetric herringbone grooves or spiral grooves to pump upward toward the upper end of the inner circumference of the sleeve, the fluid lying between the sleeve and shaft while the sleeve is rotating, and
a channel formed in the sleeve and having an intake portion near the top end of the inner periphery of the sleeve and an outlet portion near the periphery of the bottom end of the sleeve, the intake portion being located radially inside the outlet portion, the channel continuously extending from the intake portion to the outlet portion, whereby the lubricating fluid is thrown out into the intake portion by centrifugal force near the top end of the inner periphery of the sleeve, and is conveyed from the intake portion to the outlet portion through the channel by centrifugal force and/or through a slanted channel in circumferential direction through the channel with the lubricating fluid being discontinuous.

2. The fluid dynamic bearing motor according to claim 1, wherein:
the annular member opposes to a bottom end and a lower periphery of the sleeve with a gap;
the lubricating fluid lying in the gaps between the sleeve and the shaft, and between the sleeve and the annular member continuously, and having at least two interfaces with air near the top end of an inner periphery of the sleeve and on the lower portion of outer periphery of the sleeve.

3. The fluid dynamic bearing motor according to claim 2, wherein:
the lower periphery of the sleeve reduces in diameter with an increasing distance from the bottom end of the sleeve, and gradually increases the gap from the opposed annular member so that the interface of the lubricating fluid with the air is retained to form an accumulation of the lubricating fluid; and
an engaging portion for regulating axial movement of the sleeve is formed in an area between the outer periphery of the sleeve and the inner periphery of the annular member where the lubricating fluid is in contact.

4. The fluid dynamic bearing motor according to claim 2, wherein
the lower periphery of the sleeve has its diameter reducing with an increasing distance from a bottom end of the sleeve, gradually increasing the dimension of the gap from the opposed annular member so that the interface of the lubricating fluid with the air is retained in the gap to form an accumulation of the lubricating fluid; and the dynamic-pressure generating groove formed on either on the annular member or the bottom of the sleeve is configured so that the intersection of the outer periphery of the sleeve with the interface between the lubricating fluid and the air during rotation of the motor lies radially inside of the periphery of the dynamic-pressure generating groove, whereby pressure is applied to near the periphery of the dynamic-pressure generating groove by centrifugal force acting on the lubricating fluid flowing at high speed, avoiding an increase of negative pressure prone to occur near the periphery of the dynamic-pressure generating groove.

5. The fluid dynamic bearing motor according to claim 1, wherein
the lubricating fluid is discontinuously filled in the channel; and
lubricating fluid pressure adjuster for adjusting the outward lubricating fluid pressure occurring in the channel around the channel outlet.

6. The fluid dynamic bearing motor according to claim 5, wherein
the lubricating fluid pressure adjuster is a dynamic-pressure generating groove that lies between the channel outlet and the fluid interface with air on the lower portion of outer periphery of the sleeve.

7. The fluid dynamic bearing motor according to claim 5, wherein
the lubricating fluid pressure adjuster is a part of the slanted channel near the outlet in circumferential direction that presses the lubricating fluid towards the channel intake.

8. The fluid dynamic bearing motor according to claim 1, wherein
the sleeve is composed of an outer member having a top end and an outer periphery, and an inner member having surfaces opposed to the shaft and the annular member; and
the channel leading from near the top end of the inner periphery of the sleeve to near the periphery of the bottom end of the sleeve is formed as a gap between the inner member and the outer member.

9. The fluid dynamic bearing motor according to claim 8, wherein
the channel is constituted by any one of a groove formed in any one of an external surface of the inner member of the sleeve and an internal surface of the outer member of the sleeve, and the outer member of the sleeve having pits and projections.

10. The fluid dynamic bearing motor according to claim 8, wherein
the top end of the outer member has an opening having a diameter smaller than the bore diameter of the inner periphery of the inner member at the top.

11. The fluid dynamic bearing motor according to claim 8, wherein
the inner member is made of a porous material having small pores, so that the channel leading from the inner periphery of the sleeve to near the periphery of the bottom end of the sleeve is formed of the small pores.

12. The fluid dynamic bearing motor according to claim 1, wherein:
a gap portion as small as the lubricating fluid can be retained by surface tension is formed continuously to the outlet portion as part of the channel;
when at rest, the lubricating fluid is absorbed and retained in the channel through the outlet portion by surface tension, so that interfaces of the lubricating fluid with air are drawn in; and
during rotation, the lubricating fluid is supplied from the channel to the gaps between the sleeve and the shaft and between the sleeve and the annular member through the outlet portion by centrifugal force.

13. The fluid dynamic bearing motor according to claim 1, wherein:
the intake portion of the channel is arranged in an area near the top end of the inner periphery of the sleeve where the gap between the fixed shaft and the sleeve increases; and
an annular projection having a small height is formed on the inner periphery of the sleeve below the intake portion so that the lubricating fluid flows into the intake portion beyond the annular projection to form a predetermined depth of accumulation of the lubricating fluid during rotation.

14. The fluid dynamic bearing motor according to claim 1, wherein:
the fixed shaft has a conical convex shape narrowing toward the top end;
the sleeve has a conical concave shape to fit to the shaft;
one or more dynamic-pressure generating grooves are formed between the shaft and the sleeve; and
at least one of the dynamic-pressure generating grooves has a lubricating fluid pumping capability toward the top end of the sleeve.

15. The fluid dynamic bearing motor according to claim 1, wherein:
the fixed shaft has a cylindrical shape;
the sleeve has a cylindrical inner periphery, is fitted to the shaft rotatably, and is opposed to the annular member at its bottom end orthogonal to the shaft;
dynamic-pressure generating grooves are formed in any one of the outer periphery of the shaft and the inner periphery of the sleeve, and any one of the annular member and the bottom end of the sleeve, respectively; and
at least the dynamic-pressure generating groove formed in either the bottom end of the sleeve or the opposed surface thereof is formed as any one of an asymmetric herringbone groove and a spiral groove having a radially inward lubricating fluid pumping capability.

16. The fluid dynamic bearing motor according to claim 15, wherein:
one or more herringbone grooves are formed in any one of the opposed surfaces of the cylindrical shaft and the inner periphery of the sleeve; and
an asymmetric herringbone groove having the capability of pumping the lubricating fluid radially inward is formed in any one of the opposed surfaces of the annular member and the bottom end of the sleeve.

17. The fluid dynamic bearing motor according to claim 15, wherein:
two herringbone grooves are formed in any one of the opposed surfaces of the cylindrical shaft and the inner periphery of the sleeve, at least one of the herringbone grooves being formed as an asymmetric herringbone groove having a lubricating fluid pumping capability toward the bottom end of the sleeve;
a pump-in spiral groove is formed in any one of the opposed surfaces of the annular member and the bottom end of the sleeve; and
the spiral groove is provided with a lubricating fluid pumping capability high enough to pump the lubricating fluid toward the top end of the sleeve against centrifugal force and the lubricating fluid pumping capability of the asymmetric herringbone groove, and pumps the lubricating fluid toward the top end of the sleeve, so that a rotating part is supported without contact by an axial load capacity obtained by increasing the pressure of the lubricating fluid at the bottom end of the sleeve through the cooperation of the asymmetric herringbone groove and the spiral groove.

18. The fluid dynamic bearing motor according to claim 15, wherein
the cylindrical shaft and a flange portion confronting to the bottom end of the sleeve are integrated into a T-shaped shaft, and a radial side of the flange exercises positional regulation while the periphery of the surface confronting to the bottom end of the sleeve and a part of a base plate are opposed and fixed in the axial direction.

19. A low-profile recording disk drive including the fluid dynamic bearing motor as claimed in claim 1, the disk drive comprising:
a housing;
a recording disk;
the fluid dynamic motor for rotating the recording disk loaded thereon; and
data access means for writing or reading data to/from a predetermined position on the recording disk,
wherein,
the fixed shaft of the fluid dynamic bearing motor is applied as a pillar to support the housing at the center.

20. A method of controlling a lubricating fluid in a fluid dynamic bearing motor having a sleeve rotatably fitted on a fixed shaft and lubricating fluid filled in a gap between the shaft and the sleeve, with interfaces with air being near the top of the sleeve and around a lower part of the sleeve, the method comprising:
pumping and conveying the lubricating fluid existing between the sleeve and the shaft, toward a top end of an inner periphery of the sleeve by asymmetric herringbone grooves or spiral grooves formed on either of confronting surfaces of the sleeve and the shaft while the sleeve is rotating;
throwing by centrifugal force the conveyed lubricating fluid into an intake portion of a channel having the intake portion near the top end of the inner periphery of the sleeve, the channel extending from the intake portion to an outlet portion formed near the periphery of the bottom end of the sleeve; and
conveying the lubricating fluid from the intake portion to the outlet portion by centrifugal force and/or through a slanted channel in circumferential direction through the channel with the lubricating fluid being discontinuous.
